(19) United States
(12) Patent Application Publication
(10) Pub. No.: US 2022/0114888 A1
(43) Pub. Date: Apr. 14, 2022

(54) System and Method for Intersection Navigation

(71) Applicant: DEKA Products Limited Partnership, Manchester, NH (US)

(72) Inventors: Karan Somaiah R. Napanda, Manchester, NH (US); Arunabh Mishra, Manchester, NH (US); Kavya Kumar, Manchester, NH (US); FNU G Siva Perumal, Manchester, NH (US); Abhayjeet S. Juneja, Manchester, NH (US)

(21) Appl. No.: 17/501,240

(22) Filed: Oct. 14, 2021

Related U.S. Application Data
(60) Provisional application No. 63/091,532, filed on Oct. 14, 2020.

(51) Int. Cl. G08G 1/095; B60W 60/00; G08G 1/01; G06N 20/00

(52) U.S. Cl. CPC G08G 1/095; B60W 60/001; G08G 1/0116; B60W 2420/42; G08G 1/0133; G06N 20/00; B60W 2420/52; G08G 1/0112

(57) ABSTRACT

System and method for determining, in real time, a location and probability of the state of a traffic light in order to navigate safely through an intersection. The system can receive both image data in real-time and previously-formulated map data. The map data can be used to determine the historical coordinates of a traffic light, and those coordinates can be transformed to the camera image frame of reference. The image at the transformed historical coordinates can be fed to a first machine learning detection model that can provide bounding boxes where traffic lights could be. The traffic light image data can be fed to a second machine learning model that can infer the probability of traffic light states.

### CROSS REFERENCE TO RELATED APPLICATIONS

This application claims the benefit of U.S. Provisional Application Ser. No. 63/091,532, filed Oct. 14, 2020, entitled SYSTEM AND METHOD FOR INTERSECTION NAVIGATION (Attorney Docket No. AA362), which is incorporated herein by reference in its entirety.

### BACKGROUND

For safe intersection crossing, an autonomous vehicle needs to be aware of and respond to traffic signals, both automotive and pedestrian signals, collectively referred to herein as traffic lights. Traffic lights require special treatment as objects to be identified because they can change location as well as state. Traffic lights can vary in color, shape, geolocation, activation pattern, and installation, and their images can suffer from typical image issues including, but not limited to, noise, exposure, and occlusions. These factors can complicate automated detection of traffic lights. It is of critical importance that traffic light object identification be accurate and timely, as late or inaccurate results could have negative consequences for the autonomous vehicle.

Autonomous traffic light detection can be carried out with the help of trained inference engines. For either moving or static traffic lights, it is necessary to determine their sizes in order to identify their states. Sensors that can assist in real-time traffic light detection can include cameras, radar, LiDAR, and others. The number and sizes of the sensors can be limited by the size and cost point of the AV upon which the sensors are mounted. Traffic lights can be detected in several different ways including, but not limited to, two-stage detection and one-stage detection. Two-stage detection includes generating proposals from regions extracted from a scene associated with the AV, and verifying, classifying, and refining the detection of the objects in the regions. One-stage detection includes mapping features directly to bounding boxes and classification scores in a single stage. Two-stage detectors generally require more inference time than one-stage detectors, and more complex training. One-stage detectors can be faster and easier to operate than two-stage detectors.

Various models are described by Pal, S. et al., Real-time Object Detection using Deep Learning: A Survey, International Research Journal of Engineering and Technology, vol. 6:10, 10/19), incorporated herein by reference in its entirety. Examples of one-stage detectors include You Only Look Once (YOLO), single shot detector (SSD), RetinaNet, and EfficientDet. The YOLO system models detection as a regression problem by dividing the image into a regular grid and performing computations on each grid cell. For each grid cell, a number of bounding boxes is predicted, along with the confidences for those boxes and the classifications of the objects in the boxes. These values are encoded as a tensor: grid size by bounding boxes/confidence scores added to the probabilities. Upgrades to YOLO (YOLOv3) are described in Redmon et al., YOLOv3: An Incremental Improvement, arXiv:1804.02767v1 [cs.CV], Apr. 8, 2018. SSD as described by Liu, W. et al., SSD: Single Shot Multibox Detector, arXiv:1512.02325v5 [cs.CV] 12/29/16 (Liu), incorporated herein by reference in its entirety, can be used, in some configurations. SSD can perform object localization and classification in a single pass, regressing an object's coordinates to its ground truth coordinates, and detecting objects and classifying the detected objects. SSD can overlay multiple prior boxes on the image, classify each of the prior boxes according to the presence of an object, and regress the prior box bounding box coordinates according to the object. SSD predicts category scores for a fixed set of default bounding boxes using convolutional filters applied to feature maps. SSD convolution filters are smaller than YOLO convolutional filters. SSD provides predictions from different feature maps of different scales, and provides separate predictors for different aspect ratios. In YOLO, a single neural network provides bounding boxes and class probabilities directly from images in one evaluation. SSDs discretize bounding boxes into a set of default boxes over different aspect ratios and scales, then generate scores for the presence of each object category in each default box. RetinaNet includes a backbone network and two task-specific subnetworks. The backbone network computes a feature map over input data. The first subnet takes the backbone output and performs object classification which predicts the probability of object presence at the spatial positions of the anchors and object classes. The second subnet performs bounding box regression which regresses the offset from each bounding box to a nearby ground-truth object, if one exists. RetinaNet is described in detail in Lin et al., Focal Loss for Dense Object Detection, arXiv:1708.02002v2 [cs.CV] 217/2018. EfficientDet is a family of neural network object detectors including a weighted bi-directional feature pyramid network, and a compound scaling method to uniformly scale the resolution, depth, and width for all backbone, features network, and box/class prediction networks at the same time. EfficientDet is described in detail in Tan et al., EfficientDet: Scalable and Efficient Object Detection, arXiv:1911.09070v7 [cs.CV] 7/27/20. Traffic lights and traffic light states can be determined by a one-stage detector.

Examples of two-stage detectors include region-based convolutional neural network (R-CNN) and region-based fully convolutional network (R-FCN). The R-CNN proposal generator is a box classifier. Run time is dependent upon the proposals. R-FCN includes position-sensitive region-of-interest pooling. Machine learning models such as ones based on convolutional neural net (CNN), region-based CNN (R-CNN), spatial pyramid pooling, fast R-CNN, faster R-CNN, You Only Look Once (YOLO), and single shot detector (SSD) can be used. CNN models are artificial neural networks which are fully connected, making them prone to overfitting data, unless they are regularized. CNNs use the hierarchical pattern in data to assemble patterns of increasing complexity, with the final result being abstracted to a feature map. R-CNNs produce bounding boxes that each contain an object and a category of the object. Spatial pyramid pooling is applied to the last convolutional layer and pools the features, aggregating information to avoid the need for cropping. Fast R-CNN runs the neural network once on an entire image, using selective search to generate region proposals. Faster R-CNN integrates region of interest generation into the neural network itself.

An inference engine can only act upon received data which, in the case of autonomous navigation, could be limited. If the inference engine, for example, doesn't recognize any features that meet the criteria of traffic lights in an intersection where traffic lights are known to exist, collision avoidance requires an alternate form of traffic light identification. Further, the traffic light could be moving.

Object tracking is challenging as target objects often undergo drastic appearance changes over time. A tracker can locate moving objects over time from sensor data. In addition, a tracker can handle the case of tracking multiple objects over time found in sensor data. A tracker includes a motion model and history of the object, including appearance of the object. The motion model can predict a possible future location of an object. Motion model techniques include optical flow, Kalman filter, Kanade-Lucas-Tomashi feature tracker, and mean shift tracking. In general, a tracker algorithm includes defining an initial state of an object, modeling its appearance, estimating its motion, and scanning the position where the object should be based on the motion estimate to locate the object. Possible tracker approaches include CNN-based offline/online trackers, for example, multi-domain network (MDnet), and long short term memory (LSTM) networks along with CNNs, for example, recurrent YOLO, which uses a YOLO network for object detection and an LSTM network for finding the trajectory of the object. A tracker described by Mallick, Object Tracking using OpenCV (C++/Python), https://www.learnopencv.com/object-tracking-using-opencv-cpp-python/, Feb. 13, 2017, incorporated herein by reference in its entirety, can also be used. A curent version of OpenCV supports several tracker types including, but not limited to, BOOSTING (a classifier that is trained at runtime with positive and negative examples), MIL (similar to BOOSTING, but considers a neighborhood around the current object to generate positive examples), kernelized correlation filters (KCF) (similar to MIL, but faster due to the exploitation of multiple overlapping regions surrounding objects), tracking, learning, detection (TLD) (tracks objects over time, localizes objects, corrects the tracker), MEDIANFLOW (tracks objects forward and backward and measures discrepancies), GOTURN (based on CNN), minimum output sum of squared error (MOSSE) (adaptive correlation that produces stable correlation filters), and channel and spatial reliability tracker (CSRT) (ensures enlarging and localization of a selected region).

Adaptive correlation filters have been successfully applied to object tracking. However, tracking algorithms relying on highly adaptive correlation filters are prone to drift due to noisy updates. Moreover, as these algorithms do not maintain long-term memory of target appearance, they cannot recover from tracking failures caused by heavy occlusion or target disappearance in the camera view.

When it is determined that a traffic light is being encountered, the state of the traffic light must be determined in order to act in accordance with traffic regulations.

What is needed is a system that timely and accurately provides the probability that a traffic light will be in a specific state. What is further needed is a system that takes advantage of an object detection inference engine that is optimized for speed and accuracy. What is further needed is a system that meets the timing and accuracy requirements of the intersection situation.

### SUMMARY

The system and method of the present teachings can determine, in real time, a location and probability of the state of a traffic signal in order to navigate safely through an intersection. Traffic signals can include any kind of possibly transitional traffic flow management device. Vehicular traffic can be managed by red-green-yellow traffic lights and any variation of the color scheme, graphics scheme, and configuration including number of bulbs, lighted arrows and other graphics, pedestrian management signals integrated with vehicular signals, and pedestrian management signals in pedestrian throughways. The traffic signals can be occluded by weather, positioning with respect to the AV, time of day, or any other reason. The system can receive both sensor data and historical data, both in real-time and non-real-time. The historical data can be used to determine the historical coordinates of a traffic light, and those coordinates can be transformed to the sensor data frame of reference.

In a first configuration, the sensor data at the transformed historical coordinates can be fed to a first machine learning model that can provide bounding boxes where traffic lights could be. In some configurations, the first machine learning model can be based on, for example, but not limited to, Lui. If no bounding boxes are found, in some configurations, a tracker can use hints where a traffic light has been seen in the past, and can provide indicators, such as bounding box corners, of an artifact at a spot that could be a traffic light. The tracker can be used if, for example, the traffic light is partially or completely occluded from the current point of the view of the sensor, but the traffic light is thought to exist considering previously-gathered data. The tracker can be used in other cases such as, but not limited to, object crossing, motion blur, viewpoint variation, scale change, background clutter, illumination variation, and low resolution.

In the first configuration, the bounding boxes or artifacts can be provided to a second machine learning model that can classify the contents of the bounding box or artifact according to the probability of the state of the traffic light at that location. In some configurations, a deep neural network architecture can be used for the second machine learning model. Classes of deep neural network architectures can include CNNs, unsupervised pretrained networks, and recurrent neural networks. CNNs have been described herein. A pretrained network is a saved network that was previously trained on a dataset. Unsupervised pretrained networks are initialized from neural networks that were trained with unsupervised criteria, such as, for example, but not limited to, deep belief or deep autoencoder. Deep belief networks can learn to probabilistically reconstruct its inputs, enabling the network to detect features. Deep autoencoder networks can include symmetrical deep belief networks whose layers represent encoding and decoding the network. In some configurations, the second machine learning model can be based on, for example, but not limited to, Szegedy et al., Going Deeper with Convolutions, arXiv:1409.4842 [cs.CV], Sep. 17, 2014 (Szegedy), incorporated herein by reference in its entirety. Szegedy describes a deep CNN architecture including a network built from convolutional building blocks. Units from earlier layers correspond to a region of the input image, and these units are grouped into filter banks. The architecture is a combination of all layers with output filter banks concatenated into a single output vector forming the input of the next state. The probability can be filtered to eliminate outliers (based on an agreed-upon set of traffic laws, for example). The state of the light can be determined by choosing the state associated with the largest log odds value across a collection of readings of the state of the traffic light.

In a second configuration, a region of interest can be identified based on the location of the AV, and that region of interest can be provided to a single machine learning model. The machine learning model can provide candidate bounding boxes which can be fed to an association model. The association model can associate historical data with the bounding boxes and provide the bounding boxes along with the traffic light state to an accumulator. The accumulator can determine which traffic light state most often occurs in the bounding box and output that state. If no bounding boxes are located, in some configurations, assistance can be requested that could help in determining the state of the traffic light.

Other configurations are contemplated by the present teachings. For example, in the first configuration, a constant value can be assigned as the traffic light state if no bounding boxes are found. In a further example, in the second configuration, a remote control operator can provide an estimate of the state of the traffic light.

### BRIEF DESCRIPTION OF THE DRAWINGS

The present teachings will be more readily understood by reference to the following description, taken with the accompanying drawings, in which:

FIG. 1 is a schematic block diagram of a configuration of the intersection management system of the present teachings;

FIG. 1A is a pictorial representation of the coordinates provided from a historical database of traffic lights of the present teachings;

FIG. 1B is a pictorial representation of bounding boxes located in image data entering the system of the present teachings;

FIG. 1C is a schematic block diagram of a second configuration of the intersection management system of the present teachings;

FIG. 1D is a flowchart of a third configuration of the intersection management system of the present teachings;

FIG. 1E is a schematic block diagram of an exemplary implementation of the system of the present teachings;

FIG. 1F is a flowchart of a fourth configuration of the intersection management system of the present teachings;

FIG. 1G is a schematic block diagram of a fifth configuration of the intersection management system of the present teachings;

FIG. 1H is a schematic block diagram of a sixth configuration of the intersection management system of the present teachings;

FIGS. 2A and 2B are pictorial representations of the intersection management system of the present teachings;

FIGS. 3A and 3B are flowcharts of a configuration of the intersection management system of the present teachings;

FIG. 4 is a flowchart of a configuration of the intersection management system of the present teachings; and

FIG. 5 is a pictorial diagram of traffic light distance computation of the present teachings.

### DETAILED DESCRIPTION

The system and method of the present teachings can use historical and real time data to determine the likelihood of a state of a traffic light.

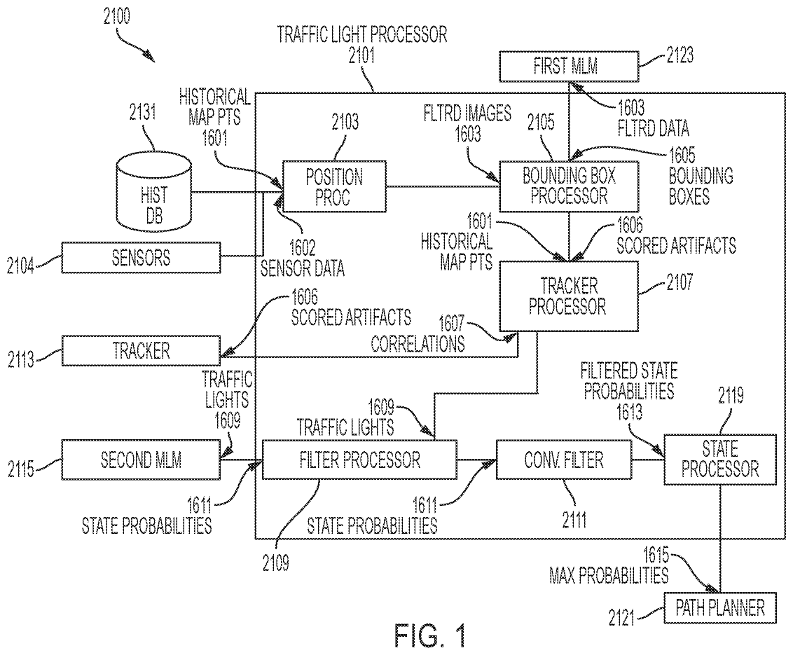

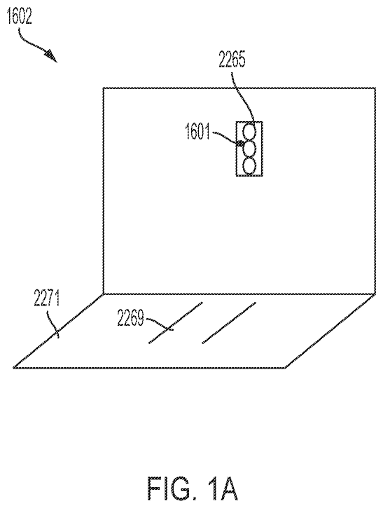

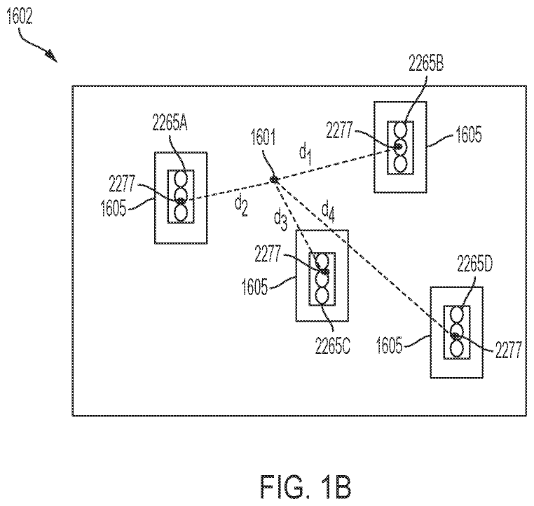

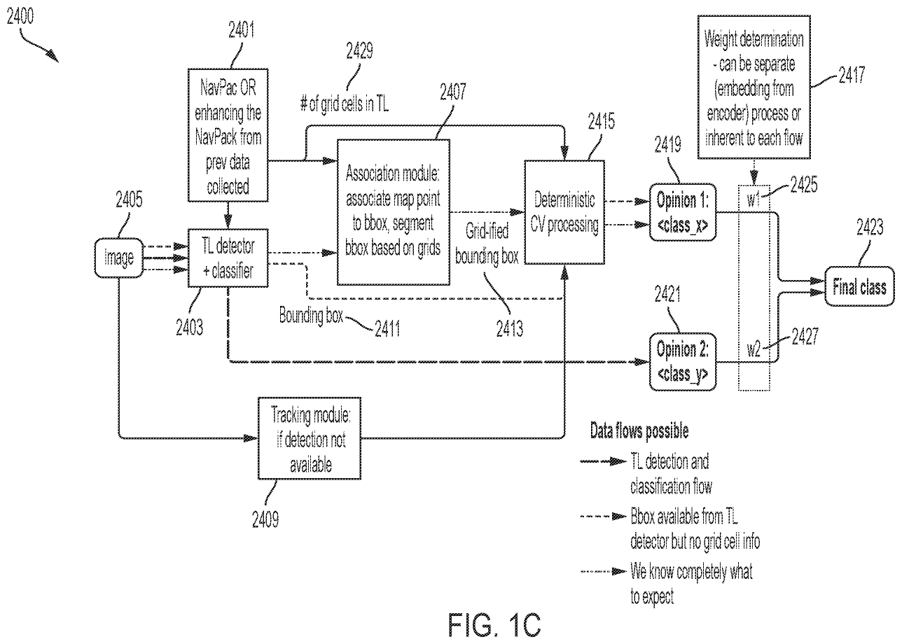

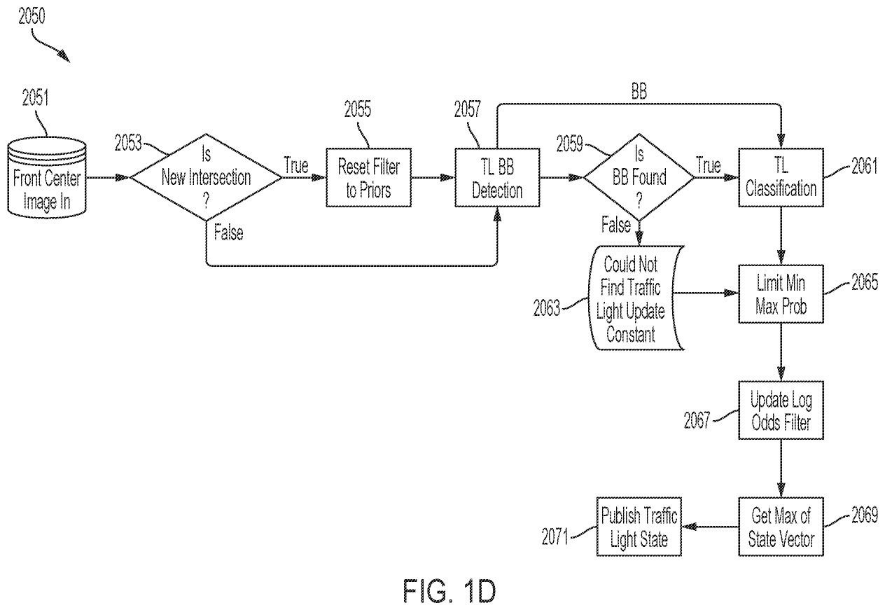

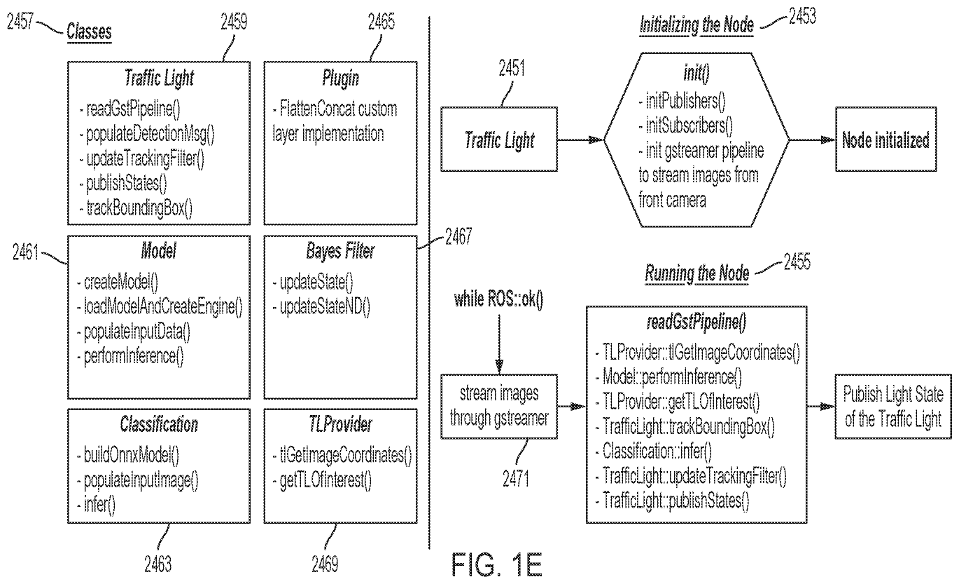

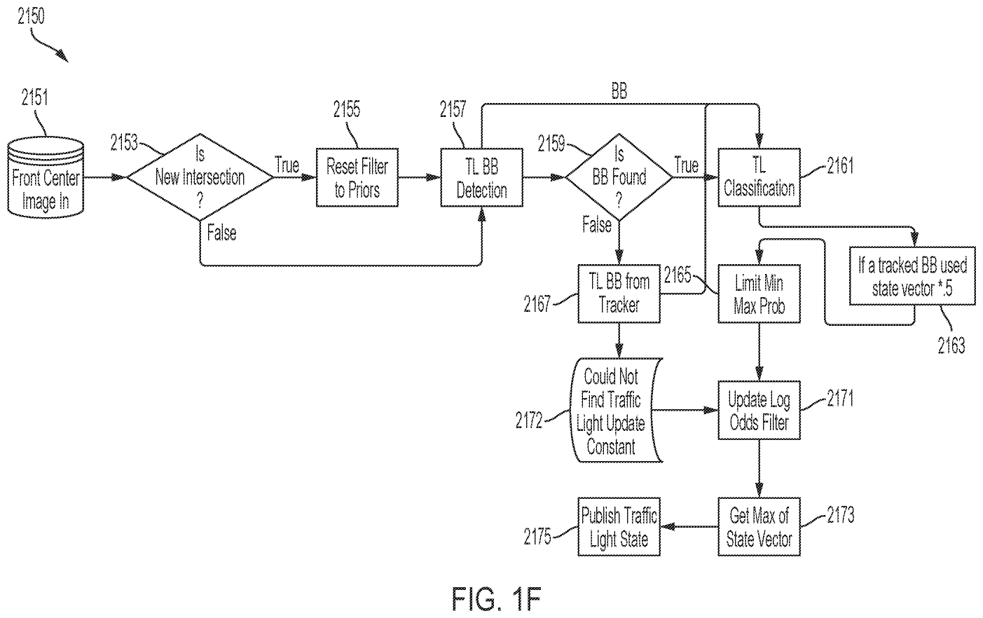

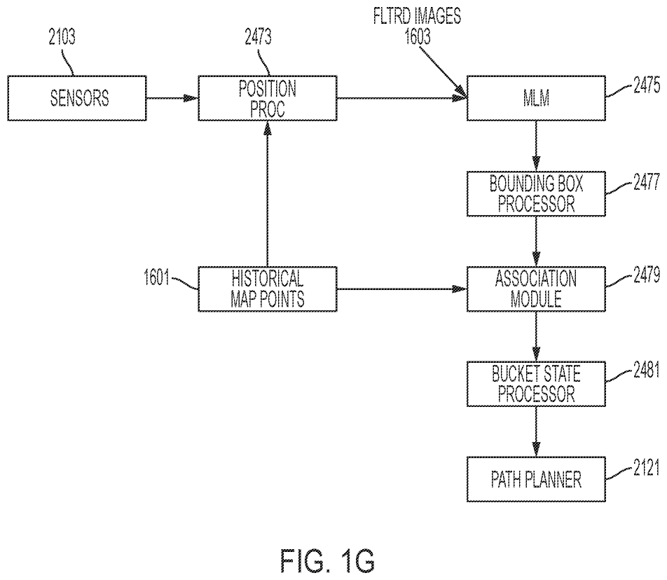

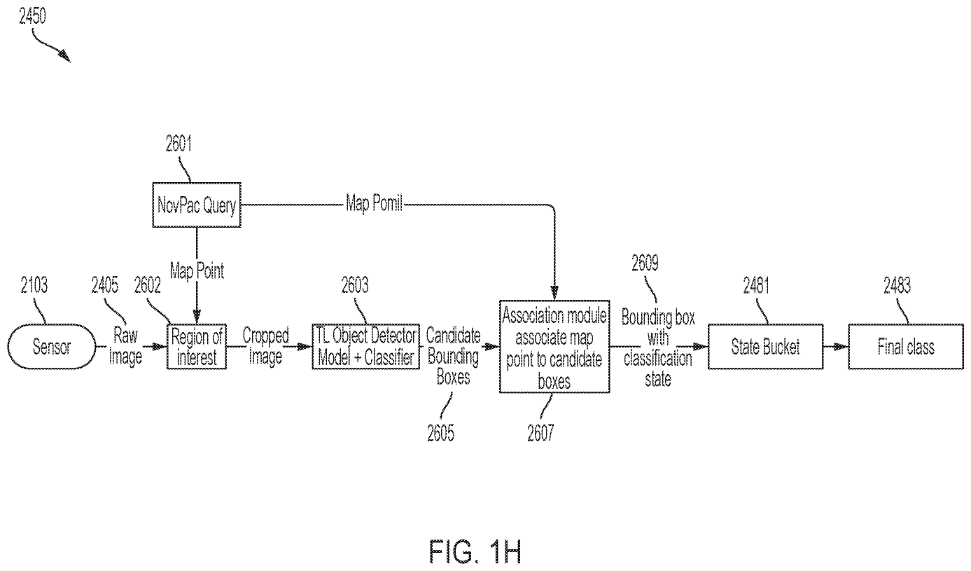

Referring now to FIG. 1, system 2100 can locate positions of traffic lights from real time sensor and historical information, and determine the probability of the states of the traffic lights. In some configurations, a map of the area in which the autonomous vehicle (AV) is navigating can include map points indicating historical locations of traffic lights. Traffic light state data can be determined from traffic lights that are encountered during navigation and that are positionally related to the map points. System 2100 can include filtering the traffic light state data and computing the maximum probability of a particular state of the located traffic light over a series of frames of sensor data.

Referring now to FIG. 1A, system 2100 (FIG. 1) can include, but is not limited to including, position processer 2103 (FIG. 1) that can access historical map points 1601 from historical database 2131 (FIG. 1) that can include traffic light information within an area of interest. Historical map points 1601 can be derived by inspecting historical data gathered previous to the real-time navigation of the AV. Historical data can include, among other things, traffic lights 2265 and roadways 2271. Roadways 2271 can include lanes 2269 that can be associated geographically with traffic lights 2265. Map points 1601 provided to system 2100 (FIG. 1) can identify which of the traffic lights in a real-time image could be associated with lane 2269.

Referring again to FIG. 1, position processor 2103 can access sensor data 1602 (FIG. 1A) from at least one sensor 2104. Sensors 2104 can include, but are not limited to including, real time sensors including cameras, LIDAR, ultrasonic, radar, temperature, proximity, accelerometer, infrared, pressure, light, and smoke/gas/alcohol. Cameras can include, but are not limited to including, charge-coupled devices (CCDs) and complementary metal-oxide semiconductor capacitors (CMOS). Some of the sensors can provide image data, and some non-image sensor data can be transformed to be used as image data. The sensors can be mounted upon the AV or mounted elsewhere, for example, but not limited to, upon utility poles, other vehicles, the road, in vegetation, on airborne vehicles, on humans, on buildings, or on animals. Sensor data 1602 (FIG. 1A) can include traffic light data 2265 (FIG. 1A). Position processor 2103 can filter sensor data 1602 (FIG. 1A). One aspect of filtering can include determining which of sensor data 1602 (FIG. 1A) are geographically coincident with map points 1601 (FIG. 1A). Further filtering can include, but is not limited to including, removal of salt and pepper noise, filtering based on aspect ratio and area of pixels (dependent upon, for example, distance from AV to the traffic light), and color-based classification. Further processing can include locating circles in the sensor data, for example, using a Hough circle transform, an Ellipse and Line Segment Detector method, geometric shape determination, mathematical morphology, contourlet transform, template matching, or segmentation based on color. Still further, a change of state of the traffic light can be determined, mask-based blob detection can be performed, colors can be clustered, and keypoints can be determined based on, for example, blob detection. Even further, the data can be cropped, depending upon the fit of the bounding box to the target feature, the color saturation of the feature, and the expected color range. For example, if the feature is a traffic light, the colors of the bulbs are expected to be red, yellow, and green. The intensity of the colors can be increased if necessary, and noise can be removed, both by conventional methods. For example, noise can be removed by applying moving averages, moving averages with non-uniform weight, a 2-dimensional weighted moving average, correlation filter, time domain filter, frequency domain filter, Gaussian filter, mean filter, median filter, and a bilateral filter. After noise is removed, a dilation (adding pixels to the boundary of the feature) followed by erosion (removing pixels from the feature boundary) (a morphological closing) can be applied to enlarge boundaries of foreground regions and shrink background color holes in the regions. The result is the filling in of small background color holes in image data. Position processor 2103 can provide filtered data 1603 to first machine learning model (MLM) 2123. First MLM 2123 can provide bounding boxes 1605 for objects located in sensor images 1602 (FIG. 1A).

Referring now to FIG. 1B, in some configurations, first MLM 2123 (FIG. 1) such as, for example, but not limited to, SSD MLM, can be trained to provide bounding boxes 1605 associated with traffic lights 2265A-D to bounding box processor 2105 (FIG. 1). First MLM 2123 (FIG. 1) can detect objects in images using, for example, but not limited to, a single deep neural network having a unified framework for training and inference. First MLM 2123 (FIG. 1) can create default boxes over different aspect ratios and scales for feature map locations. To predict the location of a particular object category, first MLM 2123 (FIG. 1) can generate scores for the presence of each object category in each default box, and can adjust the default box to match a shape of the most likely object in the box. Bounding box processor 2105 (FIG. 1) can determine the traffic light of interest to the AV based on map point 1601. For each bounding box 1605 returned to bounding box processor 2105 (FIG. 1) from first MLM 2123 (FIG. 1), bounding box processor 2105 (FIG. 1) can calculate centroids 2277, and can then calculate distance dX between centroids 2277 and map point 1601. The traffic light with the shortest dX is classified by bounding box processor 2105 as the traffic light of interest. For example, if d₂<d₃<d₁<d₄ then d₂ is the shortest distance, and traffic light 2265A is the traffic light of interest.

Referring now to FIG. 1C, sensor data can include images that can be provided to a traffic detector and classifier MLM. The traffic detector and classifier can receive historical data, and can combine that with the image data to decide a next step. Four possibilities are shown: (1) the traffic light is known and classified previously, (2) a traffic light bounding box has been detected, but there is no corresponding traffic light in the historical data, (3) a traffic light bounding box has been detected, and there is a corresponding traffic light in the historical data, and (4) a traffic light has not been detected, but a traffic light is expected to be at the location. With respect to (1), a first classification is assigned to the image in preparation for applying a weighting function determined based on, for example, but not limited to, conventional methods such as the bias method, the maximum likelihood method, and the expected value method. With respect to (2), deterministic computer vision processing is applied to the image to produce a result that depends solely on the contents of the image. In addition to the image, deterministic vision processing receives the number of grid cells in the traffic light from the historical data. In this case, the result is assigned to a second classification. With respect to (3), historical data, including the number of grid cells in the traffic light, and the image are provided to an association module that associates a map point to the bounding box, and the bounding box is segmented based on the number of grid cells. The result is also assigned to the second classification. With respect to (4), a traffic light might be at the location, but the image does not recognizably show it. In this case, tracking is invoked to locate the traffic light. If no traffic light is located, a default state can be assigned, for example, a red or unknown light. The result is subjected to deterministic computer vision processing and the historical number of grid cells in the traffic light, and the result is also assigned to the second classification. The image(s) in the first class is weighted by a first value, and the image(s) in the second class is weighted by a second value, and the final class is determined based on a combination of the weighted values. The combination can be determined by, for example, but not limited to computing a mean, a median, or a weighted mean.

Continuing to refer to FIG. 1C, in some configurations, system 2400 can be used to implement traffic light state detection as described herein. System 2400 can include MLM 2403 that can receive sensor data 2405 and historical data 2401. MLM 2403 can determine both bounding boxes associated with traffic lights and the states of the traffic lights, if sensor data 2405 includes traffic light information. MLM 2403 can supply bounding box data 2411 to both associations module 2407 and computer vision processor 2415. Computer vision processor 2415 can include a deterministic algorithm that, given a particular input, will always produce the same output. Historical data 2401 can be provided to association module 2407, and can be used to provide the number of grid cells 2429 in the traffic lights found in the historical data to computer vision processor 2415. All in all, computer vision processor 2415 can apply its algorithm to gridified bounding boxes 2413 supplied the association module 2407, number of grid cells 2429 in the traffic lights accessible from historical data 2401, bounding boxes 2411 from MLM 2403, and information from tracking module 2409 (described herein). The algorithm in computer vision processor 2415 provides first estimate 2419 of the traffic light state, while MLM 2403 provides second estimate 2421 of the traffic light state. Two estimates are exemplary only. The present teachings contemplate further traffic light state estimates from other sources including, but not limited to, collected data in addition to sensor data 2405, further sensor data processors, non-deterministic computer vision processors, deterministic computer vision processors executing a variety of algorithms, the chosen algorithm possibly being determined dynamically depending upon the AV's situation, and other processing variations. To determine which of the state estimates is the most likely to be correct, the state estimates can be weighted and combined, weighted and compared, or simply compared. Other variations are possible. If the state estimates are weighted, weight determination processor 2417 can choose weights based at least on the AV's current situation. For example, if, for any number of reasons, it seems likely that the traffic light is wholly or partially occluded, giving more weight, or selecting, first estimate 2419 might give a reasonable result because tracking data are included in the computation of first estimate 2419. On the other hand, if the situation indicates that the traffic light is fully visible from the AV, second estimate 2421 might be a better choice, or might get weighted more heavily. Final state estimate 2423 is chosen based on the considerations laid out herein, and supplied to further processors that control the movement and navigation of the AV.

Referring again to FIG. 1, if no bounding boxes 1605 are located by first MLM 2123, tracker 2113 can be used to possibly locate the corners, for example, of possible bounding boxes. Visual tracking of image frames requires adaptations to account for unreliable tracking over time that can be caused by, for example, occlusion, target rotation, and scale variation. Filters that are trained from a single frame and adapted as the appearance of the target object changes can provide these adaptations for unreliable tracking over time. A correlation filter (CF) can generate correlation peak output for an input signal. CF-based visual trackers use CFs to model the appearance of the target and update the CFs at each frame according to a fixed or dynamically-adjusted learning rate. Dynamic adjustment of the learning rate can decrease model contamination due to unreliable tracking. CFs can track complex objects through rotations, occlusions and other distractions. As an alternative to a CF, the Minimum Output Sum of Squared Error (MOSSE) filter produces stable filters when initialized using a single frame. Tracker 2113 based upon MOSSE filters is robust to variations in lighting, scale, pose, and nonrigid deformations while operating at a high frame/second rate, for example, at over 600 frames/second. Occlusion is detected based upon the peak-to-sidelobe ratio, which enables tracker 2113 to pause and resume where it left off when the object reappears. Tracker processor 2107 can combine scored artifacts 1606 (traffic lights of interest) received from bounding box processor 2105 and correlation results 1607 from tracker 2113 to track objects that could be traffic lights and provide the objects to filter processor 2109. Tracker processor 2107 can receive scored artifacts 1606 associated with traffic lights from bounding box processor 2105, and can determine which of scored artifacts 1606 are relevant to the current location of the autonomous vehicle by accessing historical map points 1601. Tracker processor 2107 can provide the relevant of scored artifacts 1606 to tracker 2113, perform another iteration over a subsequent frame, and provide those scored artifacts 1606 to tracker 2113. Tracker 2113, trained to discover traffic lights, returns correlations 1607 associated with scored artifacts 1606. If tracker 2113 returns correlation 1607 that is greater than a pre-selected threshold, scored artifact 1606 will be labeled as traffic light 1609. In some configurations, the pre-selected threshold can include 0.3. Tracker processor 2107 can crop bounding boxes 1605 from objects identified as traffic lights 1609, and traffic lights 1609 can be tracked. Tracker processor 2107 supplies traffic lights 1609 to filter processor 2109 which provides traffic lights 1609 to second MLM 2115. Tracker processor 2107 can check that tracker 2113 has in fact provided traffic light information for the traffic light of interest. If tracker 2113 provides bounding box dimensions that are not consistent with the dimensions received from first MLM 2123, the traffic light dimensions that are returned from first MLM 2123 are checked for consistency with known values. If the dimensions received from first MLM 2123 not consistent, the traffic light information can be discarded and the state of that traffic light set as unknown.

Continuing to refer to FIG. 1, MLM #1 2123 can have been trained to locate bounding boxes 1605 within the dataset, if any objects are present that MLM #1 2123 has been trained to recognize, traffic lights, for example. If MLM #1 2123 cannot detect bounding boxes 1605 in the dataset, the dataset can be supplied to tracker 2113. Tracker 2113 can locate candidate traffic lights from the data and can provide hints about the locations of corners of bounding boxes associated with the candidate traffic lights. Either bounding boxes 1605 or the hints can be provided to MLM #2 2115. MLM #2 2115 can have been trained to provide probabilities of the states of the traffic lights in bounding boxes 1605, or the traffic lights located from the hints.

Continuing to refer to FIG. 1, second MLM 2115, a convolution model, determines the probability that traffic light 1609 is in a particular state, for example, red, green, or unknown. Both first MLM 2123 and second MLM 2115 are trained offline to perform online inference. The training process can include, but is not limited to including, accessing image data including images of traffic lights, and providing the images to the MLMs. Second MLM 2115 can be fine-tuned after its initial training by providing benchmark data that have been oversampled in the representative classes. The data can include traffic light off state data for regular traffic lights and for, for example, tiny pedestrian signs. Pedestrian signs are translated from their customary colors to red, green, or unknown.

Continuing to refer to FIG. 1, second MLM 2115 provides state probabilities 1611 for traffic lights 1609 to filter processor 2109. Raw values of state probabilities 1611 that candidate traffic lights 1609 are in certain states can be processed without limiting them, or can be limited to ensure that the data fall within known upper and lower bounds. Conventional filter 2111 can be subject to saturation if the dataset is not bounded. Conventional filter 2111 can compute upper and lower bounds on the data according to the characteristics of the dataset. For example, the upper bound can be limited to the data point that has a probability value that is a pre-selected percentage of the highest probability value in the dataset. For example, the upper bound can be set to 99.99%. In this configuration, the upper bound on the dataset would be set to just below the maximum probability value in the dataset, and all data points above the upper bound would be filtered out. If the upper bound is 99.99%, the highest probability value of the data would be ln(0.9999/0.0001)=9.21024. The lower bound, in a symmetrical filter, would be 0.01%, or ln(0.0001/0.9999)=−9.21024. In some configurations, with a data collection rate of, for example, but not limited to, 20 frames/second, 0.05 sec per frame, where five frames could be collected in % second, the lower bound could be computed as follows: 9.21024/5=1.842→1−(1/(1+e\hat{ }1.842))=1−(1/(1+6.30914))→1−(1/(7.30914))→1−(0.136815)=0.863185=86.3185%. The lower bound would therefore be 1−0.863185=0.1368=13.68%. In some configurations, the data collection rate can vary from 15-30 frames/second.

Continuing to refer to FIG. 1, with respect to determining state probability 1611 that traffic light 1609 takes on a particular state, data from candidate traffic lights 1609 are gathered over a pre-selected timeframe based upon, for example, but not limited to, the average amount of time it takes for a human to perceive the color of a traffic light. The pre-selected time can include, but is not limited to including, three seconds. Restated, the pre-selected amount of time can be used as a maximum time the system can wait before seeing the state of a candidate traffic light in order for a perceived state to still be valid. In some configurations, the pre-selected amount of time can be set to less than three seconds, for example, two seconds or 40 frames at a collection rate of 20 frames/second. Continuing to use the upper bound as 9.21024 log odds (LO)/40 Frames=0.230256 LO/Frame. In this configuration, when a state has not been detected, the probabilities can be set as follows: unknown state=0.230256, red state=−0.230256, and green state=−0.230256. These settings will drive unknown up and red/green down within two seconds. When the prior knowledge of the red/green state of a candidate traffic light is unknown, then the odds that the light is either red or green are 50%=0.0 log odds (LO). The prior knowledge of an unknown light state is based upon whether the light can be seen from the angle of the sensor and if the light is acutely on. In some configurations, the route has been mapped and the locations of traffic lights are known. In this case, the likelihood that the traffic light is in the off state can be based upon power outages as stated, for example, in “Average frequency and duration of electric distribution outages vary by states”, U.S. energy Information Administration, https://www.eia.gov/todavinenergy/detail.php?id=35652) Apr. 5, 2018. An estimated worst case situation is when there are 2.6 power outages at 10.4 hours/power outage→2.6*10.4=27.04 hours→365*24=8760 hours per year→0.003086→0.3% of the time. Therefore the log odds of the probability that the traffic light is in an off state due to a power outage is ln(0.003/(1−0.003))→ln(0.003/0.997)=−5.80613. In this case, the probability values can be set to unknown=−5.80613, red=0, and green=0.

Continuing to refer to FIG. 1, conventional filter 2111 such as, for example, but not limited to, a Bayes filter as described in Hosseinyalamdary et al., A Bayesian approach to traffic light detection and mapping, ISPRS Journal of Photogrammetry and Remote Sensing 125:184-192, March 2017, can be used to filter the state probabilities 1611 of traffic lights 1609. A Bayes filter can calculate, for example, the probabilities of multiple beliefs to infer the state of the traffic light. The Bayes filter enables continuous updating of a most likely state based on the most recently acquired sensor data. The Bayes filter begins with information in the form of a probability distribution of traffic light state derived from data collected previous in time to the current situation. Collected sensor images 1602 are used to compute an observed probability distribution of the traffic light state. The Bayes filter determines the likelihood of the observed distribution as a function of parameter values, multiplying the likelihood by the previous probability distribution, and normalizing the result to obtain a unit probability over all possible values. The mode of the distribution becomes the parameter estimate and probability intervals can be calculated using a standard process. For each possible traffic light, the Bayes filter can infer, from the multiple state beliefs, the likelihood that the traffic light is in a specific state. When there are multiple states returned from the Bayes filter, perhaps because the traffic light is changing state over time, state processor 2119 can choose the maximum of state probabilities 1611. State probabilities 1611 can be used by, for example, path planner 2121 to determine, in part, where the autonomous device should move, in particular, whether the autonomous device should move through an intersection.

Continuing to refer to FIG. 1, in some configurations, conventional filter 2111 can be tuned to further its accuracy. For example, conventional filter 2111 can track the state of traffic light 1609, and, when traffic light 1609 isn't found in an expected location, a pre-selected value indicating that the state is unknown can be provided to conventional filter 2111. Conventional filter 2111 can choose the highest of state probabilities 1611 when there are multiple of state probabilities 1611. In some configurations, the value representing the green light state can be set high enough to ensure confidence in the value.

Continuing to refer to FIG. 1, in some configurations, rules taking into account the state of the traffic light can further dictate the movements that should be undertaken by an autonomous vehicle. For example, in some configurations, if the traffic light state is determined to likely be green while the autonomous device approaches the intersection, the autonomous device can be directed to drive through the intersection without stopping. In some configurations, if the traffic light state is determined to likely be red or yellow during the approach to the intersection, the autonomous device can be directed to stop at the stop line of the intersection ±1 m. In some configurations, if the traffic light state is determined to likely transition to red after the autonomous vehicle has passed a point of no return in the intersection, the autonomous device can be directed to continue following an intended path without stopping, while also avoiding perceived obstacles. In some configurations, the autonomous device can follow these rules when crossing a crosswalk with and without a pedestrian signal, a sidewalk to road and road to sidewalk transition, a right of way intersection, overlapping sidewalks, a stop sign intersection, and an intersection with a traffic signal.

Continuing to refer to FIG. 1, in some configurations, traffic light data structures can include, but are not limited to including, associated data such as a weather tag (sunny, cloudy, rainy, drizzling), time of day tag (morning, afternoon, evening, night), location tag (street address), orientation of traffic lights (vertical, horizontal), type of light (traffic, pedestrian), type of individual light (circle, arrow), and intersection tag. A data point can sometimes include more than one feature. Tags can be used to filter information depending upon what is needed to focus on at the current time. For example, if, in a scene, there traffic lights and other features, and if the AV is riding on a road, the tag can be used to inform the AV to focus on the traffic light.

Referring now to FIG. 1D, if a constant default value is used for traffic light state if bounding boxes cannot be found, in some configurations, method 2050 for determining traffic light state can include, but is not limited to including, receiving 2051 images from a camera mounted on the front and in the center of an autonomous device. If 2053 the images indicate that the autonomous device is encountering a new intersection, method 2050 can include resetting 2055 a filter to default (initially) or previous values to that depend upon model inferences. Method 2050 can include detecting 2057 bounding boxes for traffic lights within the image data. If 2059 there are bounding boxes found, method 2050 can include classifying 2061 the traffic lights within the bounding boxes. If 2059 there are no bounding boxes found, method 2050 can include setting 2063 a probability of the state of possible traffic lights associated with the image. In either case, method 2050 can include determining 2065 a minimum and a maximum state probability that can be associated with the traffic light(s) in the image, and updating 2067 a probability value filter to include the determined minimum and maximum state probability of the states of the traffic lights. Method 2050 can include selecting 2069 the maximum probabilities from each of the states for each traffic light, and publishing 2071 the states.

Referring now to FIG. 1E, in some configurations, an implementation of the system and method of the present teachings can include a traffic light node. Operations on the traffic light node can include, but are not limited to including, initializing the node 2453 and executing the node 2455. Initializing the node 2453 can include, but is not limited to including, setting up communications with publishers, subscribers, and an application for accessing and providing sensor data to the traffic light node. In some configurations, the application can include gstreamer and the sensor data can be provided by at least one camera, but other applications and sensors are contemplated by the system and method of the present teachings.

Continuing to refer to FIG. 1E, in some configurations, objects (and data and variables) can be organized into classes 2457 of like objects that can share information, and instances of the objects can implement the work of the traffic light node. In some configurations, traffic light node classes 2457 can include, but are not limited to including, traffic light class 2459, model class 2461, classification class 2463, and traffic light provider class 2469. Traffic light class 2459 can include methods to read the sensor data, populate a detection method, update a tracking filter, publish traffic light states, and track bounding boxes. Model class 2461 can include methods to create an MLM framework, load the MLM and create the MLM engine, populate the model with input data, and perform inference using the model. Classification class 2463 can include methods to build and train MLMs to meet project goals. One such open source system that can build and train MLMs is the open neural network exchange (ONNX) model, an open format tool. Other such systems to build and train MLMs are contemplated by the system of the present teachings. Classification class 2463 can include populating the model with input images and executing an inference engine to collect all factors and variables related to the model, compiling an inference algorithm, running the algorithm, and returning a result. Traffic light provider class 2469 can include methods to get coordinates of the sensor data and get the traffic light of interest. Plugin class 2465 can be included for plugins required for executing MLMs described herein. For example, the FlattenConcat can be required by an SSD model, and can therefore be made available in the plugin class. Bayes filter class 2467 can, in some configurations, adjust the traffic light state based upon multiple inputs.

Still further referring to FIG. 1E, executing 2455 the traffic light node can include initiating methods defined for carrying out the work of the traffic light node while 2471 the traffic light node is receiving sensor data, and publishing the state of the traffic light, among other information. The initiated methods can include, but are not limited to including, getting coordinates of the sensor data, performing inference using the MLM, getting the traffic light of interest, tracking bounding boxes, executing an inference engine to collect all factors and variables related to the model, compiling an inference algorithm, running the algorithm, returning a result, updating a tracking filter based on the result, and invoking publishing the traffic light state based on the result.

Referring now to FIG. 1F, if tracking is used because bounding boxes cannot be found, in some configurations, method 2150 for determining traffic light state can include, but is not limited to including, receiving 2151 images from a camera mounted on the front and in the center of an autonomous device. If 2153 the images indicate that the autonomous device is encountering a new intersection, method 2150 can include resetting 2155 a filter to previous values. Method 2150 can include detecting 2157 bounding boxes for traffic lights within the image data. If 2159 there are bounding boxes found, method 2150 can include classifying 2061 the states of the traffic lights within the bounding boxes. If 2159 there are no bounding boxes found, method 2150 can include receiving 2167 bounding boxes from tracker. If tracker coordinates and previously-determined traffic light coordinates are inconsistent, setting 2172 the traffic list state to unknown. Method 2150 can include determining 2165 a minimum and a maximum state probability that can be associated with the traffic light(s) in the image as described herein, and updating 2171 a probability value filter to include the determined minimum and maximum state probability of the states of the traffic lights. Method 2150 can include selecting 2173 the maximum probabilities from each of the states for each traffic light, and publishing 2175 the states.

Referring now to FIG. 1G, in some configurations, the presence of a traffic light in a region of interest as well as its state can be determined by a visit to a single MLM, an association of the returned bounding boxes with historical traffic light data, and a state determination based on an accumulation of states. Specifically, the bounding boxes and the traffic light states from MLM 2475 are provided, through bounding box processor 2477, to association module 2479 along with historical data 1601 to determine to which is the correct traffic light is associated. MLM 2475 can receive filtered sensor data 1603 from position processor 2473. Position processor 2473 can use historical data 1601 to sort out which of sensor data 2104 should be provided to MLM 2475 because there are likely traffic lights in those sensor data. When MLM 2475 completes creating bounding boxes around potential traffic lights, and estimating the states of the traffic lights, bounding box processor 2477 can perform whatever filtering is necessary to prepare the bounding boxes for associating with historical data 1601. For example, bounding boxes can be fused and weighted, depending upon the AV's situation. When the correct traffic light is determined, association module 2479 turns the data over to bucket state processor 2481 that accumulates traffic light states from the traffic light bounding boxes. For the correctly associated traffic light, a bucket is updated for the respective light state, which consequently reduces the bucket for other light states. For example, if association module 2479 reports that the current light state is green, bucket state processor 2481 adds one point to the green bucket and subtracts one point from yellow and red buckets each. Bucket state processor 2481 determines the final state by finding the bucket with the maximum value. When bounding box processor 2477 finds no traffic light states, a remote control operator can be notified and can provide the state of the traffic light.

Referring now to FIG. 1H, in some configurations, the incoming sensor data can be cropped, and the bounding boxes can be supplied to the association module directly from the MLM. Specifically, sensors 2104 can supply raw images 2405 to region of interest processor 2602. Region of interest processor 2602 can also access map points from historical data using a query 2601 arranged to locate historical data in the region of interest identified by raw image data 2405. Region of interest processor 2602 can prepare cropped images based on the historical data returned from query 2601. The cropped images are provided to MLM 2603. MLM 2603 is expected to provide not only traffic light bounding boxes but also traffic light states, if available. Models that can provide both the bounding boxes and states include, but are not limited to, RetinaNet, described herein. Candidate bounding boxes 2605 are provided by MLM 2603 to association module 2607. Association module 2607 can also query historical data for map points, and use sensor data and historical data to provide bounding boxes with traffic light state 2609 to bucket state processor 2481 which has been described herein. Bucket state processor 2481 supplies final traffic light state 2483 to motion and navigation processors in the AV.

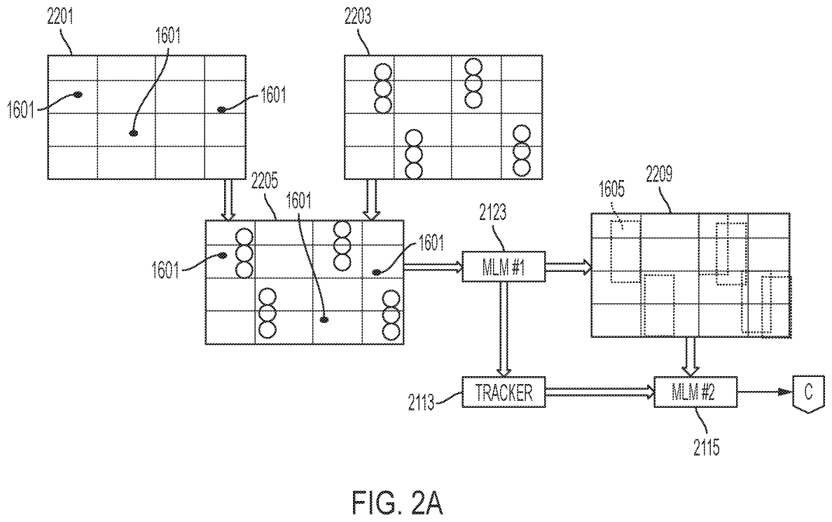

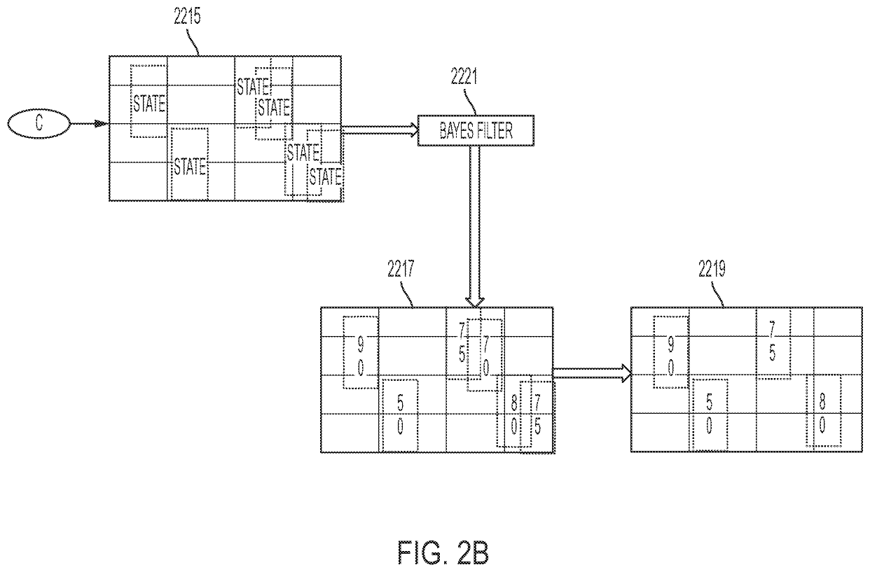

Referring now to FIG. 2A, the system of the present teachings for managing intersection traversal by an autonomous device can access historical map points 1601 that can identify the locations in which traffic lights have been found and recorded during data gathering trips. The system can also access real-time sensor data 1602 that can include traffic light images. The system can match historical location data 2201 with real-time image data 2203 and provide those data to machine learning model (MLM) #1 2123.

Referring now to FIG. 2B, traffic light state probabilities 2215 can be determined by MLM #2 2115 (FIG. 2A). Traffic light states can be provided to Bayes filter 2221 to filter the state probabilities as discussed herein. It is possible that a single traffic light can be associated with multiple state probabilities as successive image frames can reveal the traffic light moving from green to yellow to red, or simply to unknown if the traffic light becomes occluded for some reason. In that case, the highest probability state is used to determine the intersection movement of the autonomous device.

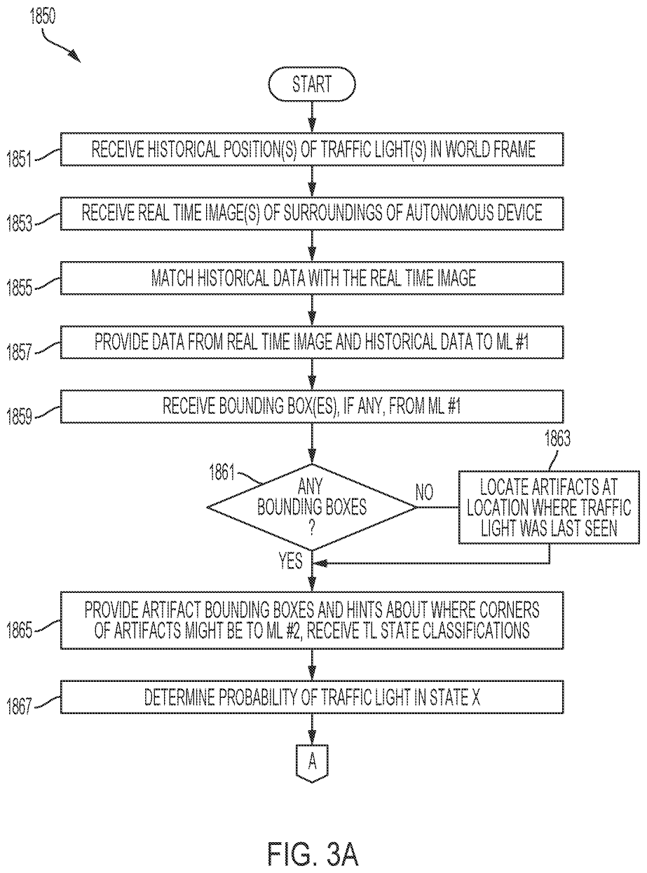

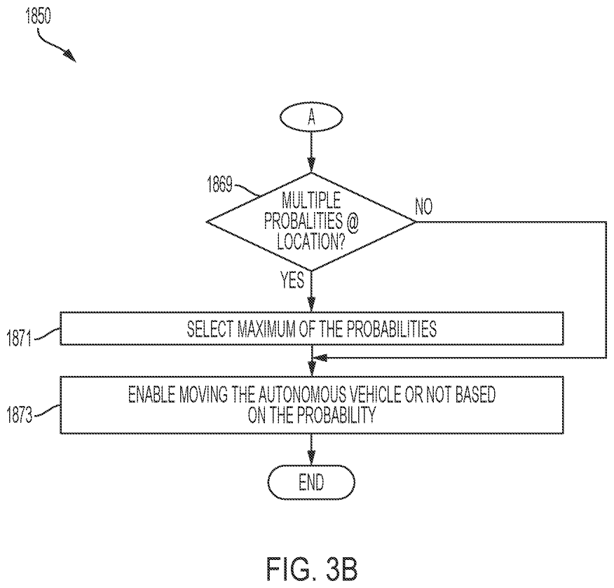

Referring now to FIG. 3A, method 1850 for managing intersection traversal can include, but is not limited to including, receiving 1851 historical position(s) of traffic light(s) (map points) in a world frame of reference, and receiving 1853 real-time image surroundings of the autonomous device, including traffic lights. The location of the traffic light as the autonomous device observes it, and the state of the traffic light, can possibly be determined from the real-time images. Method 1850 can include matching 1855 the historical data with the real-time image to associate the current images of the traffic lights with their historical locations. Method 1850 can include providing 1857 the matched data to a first machine learning model that has been trained to determine bounding boxes surrounding traffic light objects. If 1861 no bounding boxes are located, method 1850 can include locating 1863 artifacts in the data that could indicate the corners of bounding boxes surrounding traffic lights. Method 1850 can include providing 1865 the bounding boxes and the artifacts to a second machine learning model. The second machine learning model can have been trained to determine traffic light state probabilities from the image data. Method 1850 can include determining 1867 the probabilities that the traffic lights are in particular states based on the results from the second machine learning model.

Referring now to FIG. 3B, if 1869 there are multiple probabilities associated with the same traffic light, method 1850 can include selecting the maximum of the multiple probabilities. Method 1850 can include enabling 1871 moving the autonomous device or not based upon the probabilities.

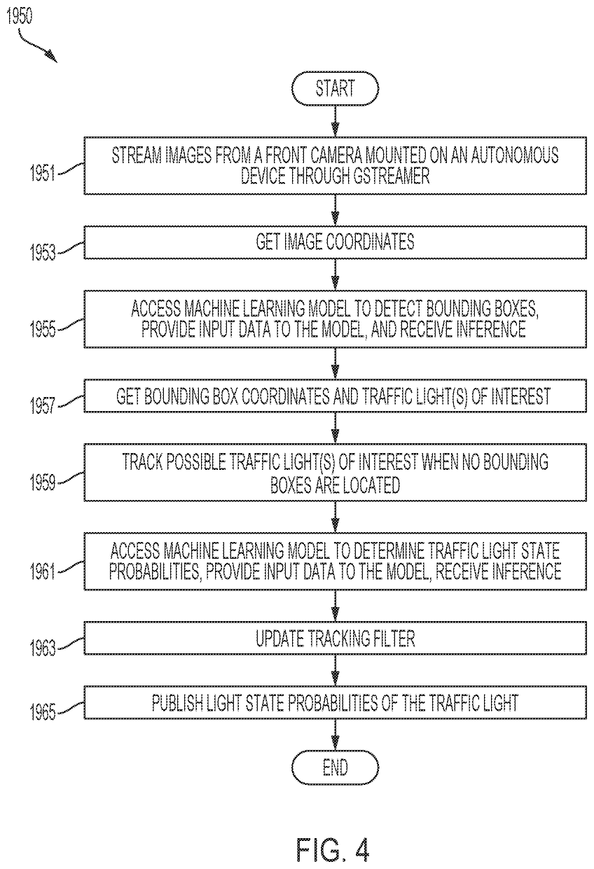

Referring now to FIG. 4, a specific configuration of the present teachings can include method 1950. Method 1950 can include, but is not limited to including, streaming 1951, using functions from the gstreamer library (https://gstreamer.freedesktop.org/), images from at least one front camera mounted on an autonomous device, and retrieving 1953, from the gstreamer output, the image coordinates of the streamed images. Method 1950 can include accessing 1955 a first machine learning model to detect bounding boxes, providing the streamed image data to the first machine learning model, and receiving inferences from the first machine learning model. Method 1950 can include accessing 1957 the bounding box coordinates, if any, from the inferences, and determining from the bounding boxes, traffic lights of interest. Method 1950 can include tracking 1959 candidate traffic lights when no bounding boxes are located. In either case, method 1950 can including accessing 1961 a second machine learning model to determine traffic light state probabilities, providing either the bounding boxes or the tracked candidate traffic lights to the second machine learning model, and receiving inferences from the model. Method 1950 can include updating 1963 tracking data, and publishing 1965 the probabilities of the traffic light states determined from the inferences.

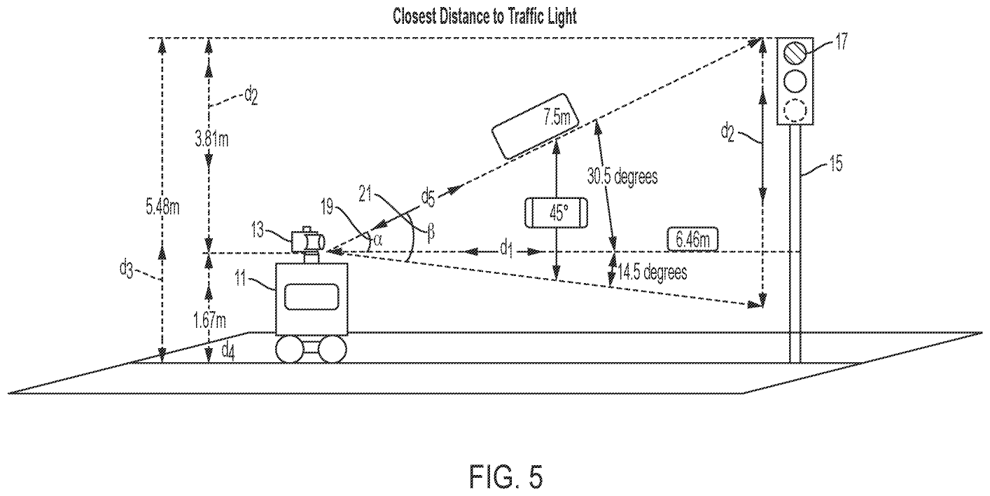

Referring now to FIG. 5, in some configurations, along with computing the state of the traffic light, the system and method of the present teachings can compute the distance from the AV to the traffic light. This distance can be required by downstream processors such as, for example, path planner 2121. AV 11 can include sensors 13 each having a field of view. Shown in the drawing is field of view of β 21, for example, 45°. Evenly splitting the field of view across a horizontal line between AV 11 and traffic light pole 15, would provide 22.5° (in the shown example) above and below the horizontal line. This situation represents sensors 13 having zero pitch. It is necessary, however, to sense traffic light 17 and its state, requiring sensors to be pitched above horizontal. In the example shown, drawing a line between sensors 13 and the top of traffic light 17, but also taking into account field of view β 21 indicates an angle between sensors 13 and the horizontal of some portion greater than half of field of view β 21, for example, 30.5°. Note that the portion of field of view β 21 will change as the position of AV 11 with respect to traffic light 17 changes. As AV 11 moves, angle α 19 between the horizontal and the line between sensors 13 and traffic light 17 changes. Values that are known as AV 11 travels can be used to compute the distance between AV 11 and traffic light pole 15. AV 11 can measure angle α 19 as AV 11 moves, and will know the height of traffic light 17 from historical data. From these known points, AV 11 can compute distance 23 between sensors 13 and traffic light pole 15 by executing the following process:

1. Subtract the distance between the surface d₄ and sensors 13 from the height of the traffic light d₃ resulting in d₂.
2. Compute the distance between sensors 13 and the top of traffic light 17, distance d₅=d₂/sin α.
3. Compute the distance between sensors 13 and traffic light pole 15, distance d₁={square root over ((d₅²)}−d₂²)

Other AV-pole distance computation options are contemplated by the present teachings. For example, if the angle of view θ of the sensor associated with the AV, the difference in height between the sensor and the traffic light, and the pitch of the sensors are known, in an aspect, the distance from the sensor to the traffic light can be computed as follows:

tan((θ/2)−pitch)=Z(traffic light)−(Z(sensor))/d(sensor->traffic light)

Z(sensor)=1.7+d(sensor->traffic light)*tan(pitch)

tan((θ/2)−pitch)=z(traffic light)−(1.7+d(sensor->traffic light)*sin(pitch))/d(sensor->traffic light)

In an aspect, the distance can be computed as follows:

d(sensor->traffic light)=(z(traffic light)−(Z(sensor))/tan((θ/2)−pitch)

Configurations of the present teachings are directed to computer systems for accomplishing the methods discussed in the description herein, and to computer readable media containing programs for accomplishing these methods. The raw data and results can be stored for future retrieval and processing, printed, displayed, transferred to another computer, and/or transferred elsewhere. Communications links can be wired or wireless, for example, using cellular communication systems, military communications systems, and satellite communications systems. Parts of the system can operate on a computer having a variable number of CPUs. Other alternative computer platforms can be used.

The present configuration is also directed to software for accomplishing the methods discussed herein, and computer readable media storing software for accomplishing these methods. The various modules described herein can be accomplished on the same CPU, or can be accomplished on different computers. In compliance with the statute, the present configuration has been described in language more or less specific as to structural and methodical features. It is to be understood, however, that the present configuration is not limited to the specific features shown and described, since the means herein disclosed comprise preferred forms of putting the present configuration into effect.

Methods can be, in whole or in part, implemented electronically. Signals representing actions taken by elements of the system and other disclosed configurations can travel over at least one live communications network. Control and data information can be electronically executed and stored on at least one computer-readable medium. The system can be implemented to execute on at least one computer node in at least one live communications network. Common forms of at least one computer-readable medium can include, for example, but not be limited to, a floppy disk, a flexible disk, a hard disk, magnetic tape, or any other magnetic medium, a compact disk read only memory or any other optical medium, punched cards, paper tape, or any other physical medium with patterns of holes, a random access memory, a programmable read only memory, and erasable programmable read only memory (EPROM), a Flash EPROM, or any other memory chip or cartridge, or any other medium from which a computer can read. Further, the at least one computer readable medium can contain graphs in any form, subject to appropriate licenses where necessary, including, but not limited to, Graphic Interchange Format (GIF), Joint Photographic Experts Group (JPEG), Portable Network Graphics (PNG), Scalable Vector Graphics (SVG), and Tagged Image File Format (TIFF).

While the present teachings have been described above in terms of specific configurations, it is to be understood that they are not limited to these disclosed configurations. Many modifications and other configurations will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A method for determining a probability of at least one state of at least one traffic light during navigation of an autonomous vehicle comprising:
accessing historical map data, the historical map data including at least one position hint of a location of the at least one traffic light;
receiving realtime image data from at least one sensor associated with the autonomous vehicle;
providing the realtime image data to a first machine learning model, the first machine learning model locating traffic light bounding boxes in the realtime image data, if present;
providing the at least one position hint to a tracker, the tracker trained to recognize categories of objects, the tracker identifying at least one location where the at least one traffic light might be located if none of the traffic light bounding boxes is present;
providing the traffic light bounding boxes, if present, or the at least one location to a second machine learning model, the second machine learning model determining at least one belief of at least one state of the at least one traffic light;
providing the at least one belief to a filter, the filter computing at least one probability from the at least one belief; and
selecting a maximum of the at least one probability.

2. The method as in claim 1 wherein the at least one sensor comprises a CCD camera.

3. The method as in claim 1 wherein the at least one sensor comprises a CMOS camera.

4. The method as in claim 1 wherein the at least one sensor comprises a vehicle-mounted device.

5. The method as in claim 1 wherein the at least one sensor comprises a pole-mounted device.

6. The method as in claim 1 wherein the at least one sensor comprises a ground-mounted device.

7. The method as in claim 1 wherein the first machine learning model comprises a SSD model.

8. The method as in claim 1 further comprising;
filtering the sensor data for geographical coincidence of located traffic lights in the sensor data with the historical traffic lights found in the historical map data.

9. The method as in claim 1 further comprising;
calculating centroids in the bounding boxes;
calculating distances between the centroids and a map point associated with the sensor data, the map point being derived from the historical map data; and
identifying the traffic light of interest based on a minimum of the distances.

10. The method as in claim 1 wherein the tracker comprises a correlation filter.

11. The method as in claim 1 wherein the tracker comprises a minimum output sum of squared error filter.

12. The method as in claim 1 wherein the second machine learning model comprises a convolution model.

13. The method as in claim 1 wherein the filter comprises a Bayes filter.

14. A method for determining at least one traffic light state of at least one traffic light during navigation of an autonomous vehicle comprising:
receiving realtime image data from at least one sensor associated with the autonomous vehicle;
accessing historical map data geographically coincident with the sensor data;
selecting a subset of the realtime image data based at least on the historical map data;
providing the subset to a machine learning model, the machine learning model locating at least one traffic light bounding box, if present, and at least one traffic light state in the subset;
associating the at least one traffic light bounding box, if present, with the historical data;
accumulating at least one number of the at least one traffic light state into at least one bucket associated with at least one value of the at least one traffic light state; and
setting a final traffic light state as the at least one value associated with a highest of the at least one number.

15. The method as in claim 14 wherein the at least one sensor comprises a CCD camera.

16. The method as in claim 14 wherein the at least one sensor comprises a vehicle-mounted device.

17. The method as in claim 14 wherein the machine learning model comprises RetinaNet.

18. The method as in claim 14 further comprising:
filtering the at least one traffic light bounding box to prepare the at least one traffic light bounding box for association with the historical map data.

19. The method as in claim 14 further comprising:
cropping the sensor data.
